(19) United States
(12) Patent Application Publication
(10) Pub. No.: US 2014/0259023 A1
(43) Pub. Date: Sep. 11, 2014

(54) ADAPTIVE VIBRATION MITIGATION

(71) Applicant: SEAGATE TECHNOLOGY LLC, Cupertino, CA (US)

(72) Inventors: Michael Howard MILLER, Eden Praire, MN (US); Richard Esten BOHN, Shakopee, MN (US)

(73) Assignee: Seagate Technology LLC, Cupertino, CA (US)

(21) Appl. No.: 13/788,425

(22) Filed: Mar. 7, 2013

(51) Int. Cl. G06F 9/46

(52) U.S. Cl. CPC G06F 9/46
USPC 718/105

(57) ABSTRACT

In accordance with one implementation, a system for adaptive vibration mitigation includes a distributed workload scheduler configured to allocate individual workloads between a plurality of storage nodes in a distributed computing and storage environment. The distributed workload scheduler synthesizes and analyzes feedback data from the storage nodes in order to modify workload scheduling policies and/or the behavior of other system components in a way that mitigates the impact of vibrations on the system.

### CROSS-REFERENCE TO RELATED APPLICATIONS

The present application is related to U.S. patent application Ser. No. ______, entitled “Peer to Peer Vibration Mitigation” and filed concurrently herewith, which is specifically incorporated by reference herein for all that it discloses and teaches.

### SUMMARY

Implementations described and claimed herein provide for adaptive vibration mitigation in a system including a virtual workload scheduler that allocates individual workloads between a plurality of storage nodes in a distributing computing and storage environment. Such allocation can be based, among other factors, on the location of each of the storage nodes within the system, the susceptibility of performance of each of the storage nodes to vibrational disturbance, and/or the performance requirements of each of the individual workloads.

This Summary is provided to introduce an election of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various implementations and implementations as further illustrated in the accompanying drawings and defined in the appended claims.

### BRIEF DESCRIPTIONS OF THE DRAWINGS

FIG. 1 illustrates a distributed computing system managed by an example distributed workload scheduler.

FIG. 2 illustrates a first distribution of subtasks assigned to a plurality of nodes in a distributed computing system by an example distributed workload scheduler.

FIG. 3 illustrates a second distribution of subtasks assigned to a plurality of nodes in a distributed computing system by an example distributed workload scheduler.

FIG. 4 illustrates a third distribution of subtasks assigned to a plurality of nodes in a distributed computing system by an example distributed workload scheduler.

FIG. 5 illustrates a fourth distribution of subtasks assigned to a plurality of nodes in a distributed computing system by an example distributed workload scheduler.

FIG. 6 illustrates example operations for adaptive rotational vibration mitigation according to one implementation.

FIG. 7 discloses a block diagram of a computer system suitable for implementing aspects of at least one implementation of an adaptive rotational vibration mitigation system.

### DETAILED DESCRIPTIONS

Rotational vibration (RV) can be a cause of hard disc drive performance problems, particularly in systems containing multiple disc drives in the same enclosure. In operation, rotational vibration in a hard drive assembly (HDA) can cause one or more tracking sensors on the HDA's actuator arm to become misaligned with a targeted data track on a disc. Such misalignment may result in improperly written data and/or significant delays in reading data from and writing data to the disc. Rotational vibration can be caused by forces including, without limitation, a drive's own actuator moment, the activity of other drives in a system enclosure, other sources of vibration, such as cooling fans, etc.

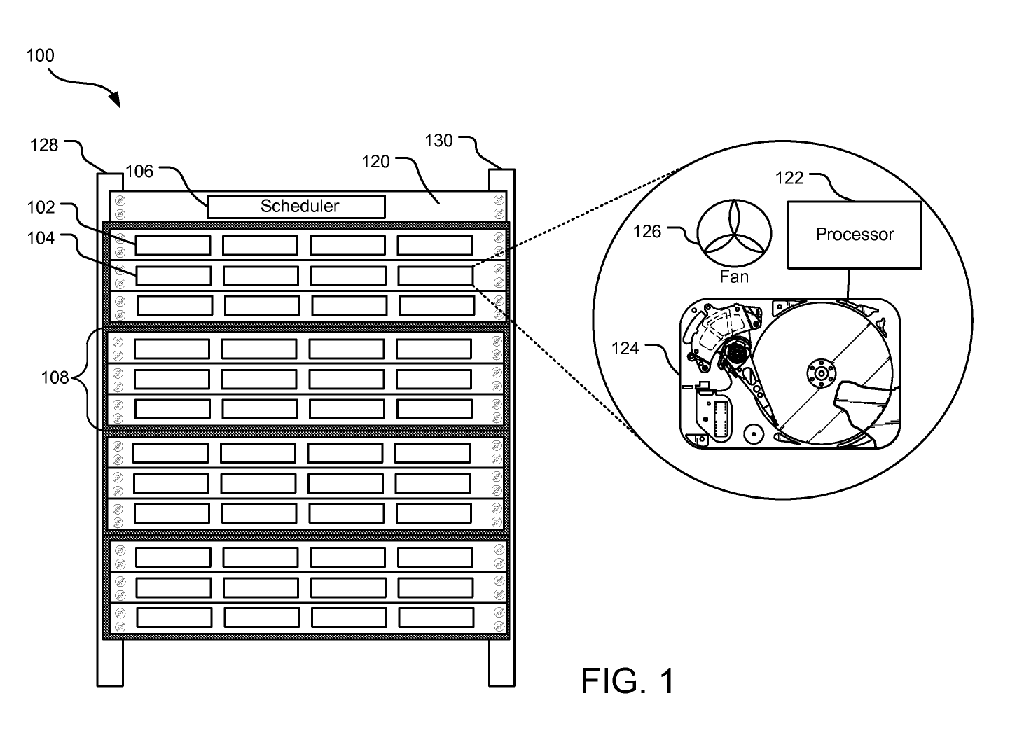

FIG. 1 illustrates a distributed computing system 100 managed by an example distributed workload scheduler 106 in one implementation. The distributed workload scheduler 106 is communicatively coupled to a plurality of storage nodes (e.g., storage nodes 102, 104) in the distributed computing system 100. Each computing node includes one or more processing units (e.g., a processor 122) coupled to one or more hard drive assemblies (e.g., an HDA 124). Typically, a cooling fan 126 cools one or more storage nodes in the distributed computing system 100. The HDA 124 of each storage node performs storage-related tasks such as read and write operations and the processor 122 of each storage node is configured to perform storage and/or computing tasks for the distributed computing system 100. Other configurations may be employed.

The HDA 124 typically includes an actuator arm that pivots about an axis of rotation to position a transducer head, located on the distal end of the arm, over a data track on a media disc. The movement of the actuator arm may be controlled by a voice coil motor, and a spindle motor may be used to rotate the media disc below the actuator arm. In operation, rotational vibrations experienced by the HDA 124 can result in unwanted rotation of the actuator arm about the arm's axis of rotation (e.g., in the cross-track direction). When severe enough, this unwanted rotation can knock the transducer head far enough off of a desired data track that a position correction is required. Such events can contribute to diminished read and/or write performance in the HDA 124 and the distributed computing system 100.

Each HDA 124 in the distributed computing system 100 communicates with at least one processor 122. The processor 122 may be able to detect a position of the transducer head of the HDA 124 at any given time based on read sensor signals sent from the transducer head or servo pattern information that is detected by the transducer head and passed to the processor 122. Thus, during a reading or writing operation, the processor 122 may detect that the drive is not tracking properly and take steps to correct the tracking. For example, the processor 122 may determine that the transducer head has hit an off-track limit when vibrations cause the transducer head to stray off of a desired data track. In such cases, the processor 122 may instruct the drive to halt the current reading or writing operation for one or more rotations of the disc so that the transducer head can be repositioned.

The processor 122 of each of the storage nodes collects information from the HDAs 124 of each storage node regarding the degree to which the performance of the HDAs 124 is degraded by both rotationally induced vibrations (e.g., rotational vibration or “RV”) or other, non-rotationally induced vibrations. Each processor 122 of each storage node then reports this performance degradation information back to the distributed workload scheduler 106. As used herein, the term “performance degradation” refers to I/O degradation attributable to system vibrations.

Vibrations that contribute to performance degradation can be caused by a variety of factors, which are hereinafter referred to as “performance degradation factors.” These performance degradation factors include without limitation: the position of a storage node in a chassis or rack; local and/or internal storage node conditions; the types of tasks performed on each storage node and adjacent storage nodes at any given time; and the physical degradation (e.g., a reduction in quality, strength, performance, etc., due a physical change) of one or more system components.

In one implementation, the processor 122 in one of the storage nodes measures I/O degradation attributable to system vibrations occurring at the node and reports this information to the processor 122 of the distributed workload scheduler 106. In another implementation, the storage nodes include vibration sensors and the processor 122 in each of the storage nodes reports vibration sensor measurements back to the distributed workload scheduler 106.

The distributed workload scheduler 106 is configured to distribute workload subtasks between the plurality of storage nodes in the distributed computing system 100. As used herein, the term “subtasks” may refer to subtasks of a single workload, or subtasks relating to multiple different workloads. The term “workload” as used herein refers to one or more subtasks within a storage operation. One example of a workload is a user query that requires a reading of data from multiple storage nodes. For example, a researcher may want to know how many people in the U.S. named Bob live at a street address less than 1000. The data in this collection could be physically stored across multiple storage nodes in a distributed computing system. In this case, a storage node may be assigned the subtask of searching its associated HDAs 124 and counting records of people matching the search criteria.

Another example of a workload is an address book entry in a database. A subtask of the address entry workload is then entering a field associated with the address, such as a name. Other subtasks of this workload are entering a street address, a phone number, an email address, etc. In one implementation, each of these fields may be stored in a different HDA 124 associated with a different storage node in the computing system 100. In another implementation, each of these fields may be written to and stored in the same HDA 124 of the same storage node.

At times, the distributed workload scheduler 106 may actively schedule multiple workloads simultaneously. For example, the distributed workload scheduler 106 may simultaneously schedule workloads A and B, and subtasks related to both workload A and workload B may be run on the system at the same time. As discussed in the above example, a first researcher may execute a workload to determine how many people named Bob live in the U.S. at a street address less than 1000. At the same time, a second researcher might utilize the same distributed computing system to count all of the people named “Jane” who live in Alabama. Here, both of the workloads may execute simultaneously on the distributed computing system.

In one implementation, the storage nodes are able to accept only one subtask at a time; however, in another implementation, the storage nodes can be assigned multiple tasks at the same time.

In the example illustrated by FIG. 1, the distributed workload scheduler 106 resides on a single, rack-mounted computer server 120. However, in alternate implementations, the distributed workload scheduler 106 may be distributed across one or more of the processors 122 of the storage nodes or across other processors or other systems of processors.

The storage nodes (e.g., storage nodes 102, 104) illustrated in FIG. 1 are distributed across multiple chassis (e.g., a chassis 108) mounted on racks 128, 130. In some cases, one or more rack-mounted chassis racks may be kept in a cabinet. Each chassis 108 includes multiple storage nodes and a plurality of cooling fans (e.g., fan 126). In one implementation, the cooling fan 126 is positioned immediately behind a vertical stack of three storage nodes. In another implementation, one or more of the processors 122 of storage nodes in close physical proximity to the cooling fan 126 controls the cooling fan 126. The processor 122 that is in control of the cooling fan 126 may also be a chassis level controller, which may control and/or monitor conditions and/or performance degradation within each of the storage nodes. In alternate implementations, the storage nodes may be distributed in a variety of configurations that may employ any number of racks, chassis, or fans. In at least one implementation, the configuration includes storage nodes at two separate physical locations (for example, in different facilities). In alternate implementations, each chassis (e.g., the chassis 108) may also include one or more temperature, humidity, or GPS sensors.

In one implementation, the distributed workload scheduler 106 collects information from the distribution computing system 100 and/or from system users regarding the input/output (I/O) performance requirements for each of the workloads to be scheduled. In the same or an alternate implementation, a distributed workload scheduler 106 collects information regarding the vibrational susceptibility of one or all of the storage nodes in the distributing computing system 100.

The term “vibrational susceptibility,” as used herein, refers to a storage node's susceptibility to performance degradation, including but not limited to performance degradation caused by rotational vibration. The vibrational susceptibility of a storage node may be determined for a single point in time, multiple points in time, or over a given interval of time. For example, a storage node may have a first vibrational susceptibility at a first timestamp and a second vibrational susceptibility at a second timestamp. Here, the distributed workload scheduler 106 may analyze the relative difference between the two vibrational susceptibilities to make adaptive scheduling decisions. In another example implementation, the storage node's vibrational susceptibility is determined in relation to one or more time intervals having a distinct start and stop timestamp. For example, the vibrational susceptibility may be determined for a given minute, hour, day, month, etc.

The vibrational susceptibility of a storage node can be inferred from performance degradation detected in the storage node that occurs in the presence of one or more of the performance degradation factors. Using the workload performance requirements and/or feedback from the storage nodes, the distributed workload scheduler may adaptively schedule system workloads to mitigate the total performance degradation of the system.

The vibrational susceptibility of a storage node in the distributed computing system 100 may depend on both static and dynamic variables. In one implementation, the vibrational susceptibility of a storage node depends upon the position of the storage node within the distributed computing system 100. For example, the chassis 108 may have various “weak spots” incident to the design of the chassis. Thus, a particular region of the chassis may be more susceptible to vibration than other spots. Therefore, a drive positioned within one of the weak spots is generally more susceptible to vibrational problems than drives positioned elsewhere in the chassis 108.

In one implementation, the vibrational susceptibility of a storage node in the distributed computing system 100 depends on local and internal storage node conditions such as temperature, humidity, altitude, and power supply restrictions in each of the storage nodes. For example, a storage node having a temperature that is warmer than average may be more susceptible to performance degradation than a cooler storage node. Likewise, the vibrational susceptibility of a storage node may depend upon the relative humidity of the storage node or the altitude of a facility where part or all of the distributed computing system 100 is located. Therefore, the distributed workload scheduler 106 may obtain storage node condition information pertaining to temperature, humidity, power supply, altitude, etc., to be used for adaptively distributing workloads between the storage nodes.

In the same or an alternate implementation, the vibrational susceptibility of a storage node depends upon the quality, composition, and/or degradation of one or more components in the HDA 124 of the storage node. For example, an older HDA 124 may be more susceptible to performance degradation than a newer HDA 124. Also, HDAs 124 made out of inexpensive, weaker materials may be more susceptible to performance degradation than more expensive, sturdier HDAs 124. Thus, each storage node in the distributed computing system 100 may have a unique vibrational susceptibility independent of the storage node's position within the distributed computing system 100 or of other system-dependent variables (such as heat and humidity).

In yet another implementation, the vibrational susceptibility of a storage node in the distributed computing system 100 depends on the location of the storage node within the distributed computing system 100. In one implementation, the vibrational susceptibility of a storage node depends upon the location of the storage node relative to active computing operations on other storage nodes in the distributed computing system 100. For example, a workload subtask having higher than average I/O requirements may create vibrations likely to affect nearby storage nodes. Therefore, the proximity of a storage node to active computing operations on adjacent storage nodes can degrade I/O performance of that storage node, increasing the storage node's vibrational susceptibility. Accordingly, the distributed workload scheduler 106 may be capable of identifying and monitoring high I/O subtasks (also referred to herein as “aggressor tasks”) and adaptively assigning or distributing such subtasks across the system so as to mitigate the associated vibrational impact.

In another implementation, the vibrational susceptibility of each storage node in the distributed computing system 100 depends on the type of subtasks being performed by each of the storage nodes. For instance, a write operation may require more precise tracking than a read operation of the same size. Thus, a storage node performing a write operation may be more vulnerable to performance degradation than a storage node performing a read operation. Therefore, the distributed workload scheduler 106 can increase performance of the distributed computing system 100 by avoiding scheduling subtasks that cause such vibrational vulnerability on storage nodes adjacent to storage nodes that are performing aggressor tasks.

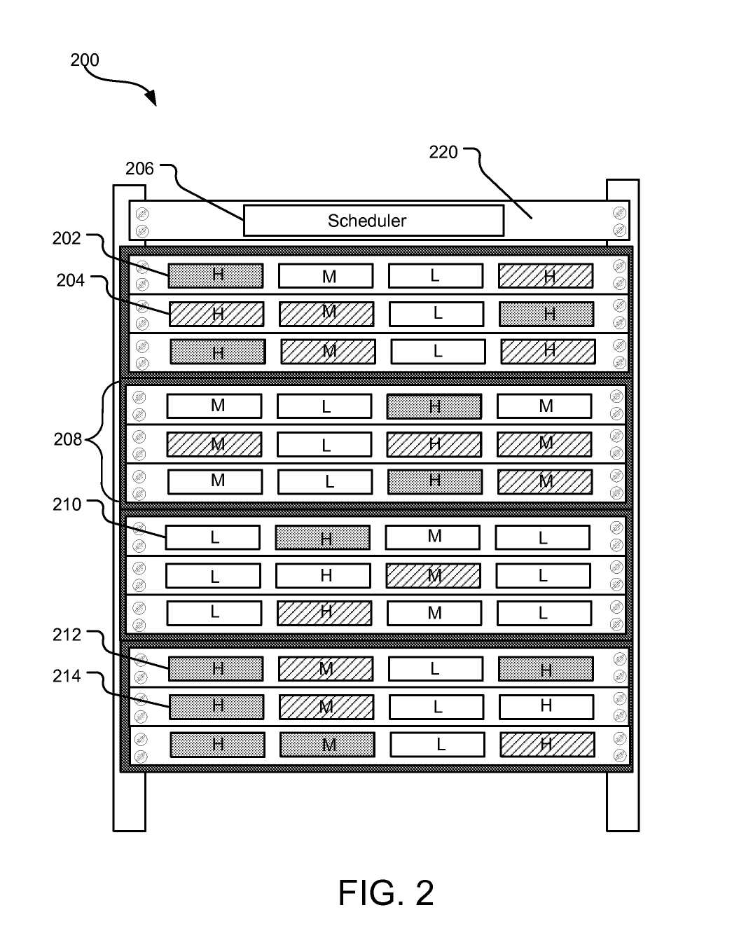

FIGS. 2-5 show example steps for vibration mitigation. These steps are a matter of design choice and may be performed in isolation, in any combination, and/or in any order, unless explicitly claimed otherwise or a specific order is necessitated by the claim language.

FIG. 2 illustrates a first distribution of subtasks assigned to a plurality of storage nodes (e.g., storage nodes 202, 204) in a distributed computing system 200 by an example distributed workload scheduler 206. The distributed workload scheduler 206 is communicatively coupled to the plurality of storage nodes (e.g., the storage nodes 202, 204) in the distributed computing system 200 and receives information from the storage nodes regarding the degree of performance-limiting vibration being experienced at each respective storage node.

In one implementation, the storage nodes include vibration sensors and a processor of each storage node reports sensor measurements back to the distributed workload scheduler 206. In the same or an alternate implementation, the distributed workload scheduler 206 assesses the amount of vibration being experienced at each storage node based on the time required to complete one or more assigned subtasks at the storage nodes.

Three different example workloads (H, M, and L) are shown, each comprising many parallelizable subtasks that the distributed computing distributed workload scheduler is responsible for submitting to the distributed computing storage nodes (e.g., the storage nodes 202, 204) for execution. It is assumed that each of the subtasks may be executed in roughly the same amount of time when given identical hardware resources. The workload “H” represents a workload having higher than average disc I/O requirements; the workload “M” represents a workload having average disc I/O requirements; and the workload “L” represents a workload having lower than average I/O requirements. However, in the illustrated example, it may be assumed that the scheduler 206 does not initially have knowledge of the I/O requirements of each of the subtasks and/or workloads.

After distributing the subtasks for execution, the distributed workload scheduler 206 gathers data from each of the storage nodes (e.g., storage node 202, 204) regarding the amount of I/O degradation observed during or after the execution of each task. In one implementation, it is assumed that I/O degradation in a storage node is entirely attributable to the vibrational impact on the storage node. In the example implementation illustrated, the processors in many of the storage nodes report to the distributed workload scheduler 206 that they have experienced unexpectedly slow disc I/O and that their performance was impacted as a result.

The distributed workload scheduler 206 learns that the subtasks shown in white (e.g., the subtask assigned at storage node 210) executed in one minute, subtasks shown with hashed lines (e.g., the subtask at storage node 204) executed in two minutes, and subtasks shown in gray (e.g., the subtask at storage node 202) executed in three minutes. The distributed workload scheduler 206 uses this data to attempt a second distribution of subtasks that reduces performance degradation observed in the first distribution 200.

The distributed workload scheduler 206 is configured to perform a subsequent workload distribution based on a number of different observations, inferences, and/or assumptions. In one implementation, the distributed workload scheduler 206 in the current example observes that the storage nodes at the lower left corner of the bottom chassis have reported higher than average I/O degradation. To attempt to remedy this problem, the distributed workload scheduler 206 makes a preliminary assumption that one or more of the subtasks assigned to the lower left corner of the bottom chassis are aggressor tasks, which are creating disturbances in the region. The distributed workload scheduler 206 assesses the amount of performance degradation reported by each storage node to try to identify the subtasks that are the aggressor tasks, and then decides to distribute the identified aggressor subtasks evenly across the distributed computing system 200 in a subsequent distribution.

In another implementation, the distributed workload scheduler 206 observes the higher than average I/O in the lower left corner of the bottom chassis and determines that due to a design or structural fault, the lower left corner of the bottom chassis is more susceptible to performance degradation than other areas in the distributed computing system 200. The distributed workload scheduler 206 uses the storage node feedback to infer which subtasks are “high workload” subtasks (i.e., aggressor tasks), and make a subsequent distribution that avoids assigning the high-workload subtasks to the problem area.

In yet another implementation, the distributed workload scheduler 206 makes an assumption that the I/O degradation of the lower-left corner of the bottom chassis is primarily due to the physical degradation of one or more HDAs in the region. Again, the distributed workload scheduler 206 uses the storage node feedback data to infer which subtasks are aggressor subtasks and makes a subsequent distribution that avoids assigning the aggressor subtasks to the physically degraded storage nodes. In another implementation, the distributed workload scheduler 206 alters the temperature of a storage node by instructing the processor of the storage node to alter a fan speed. In yet another implementation, the distributed workload scheduler 206 notifies a system administrator of a persistent problem in a storage node.

In the same or an alternate implementation, the distributed workload scheduler 206 makes inferences about the vibrational susceptibility of system components by observing storage node feedback from a variety of workload distributions over time. For example, the distributed workload scheduler 206 may be capable of identifying physically degraded storage nodes in need of service or repair by observing small problems that gradually increase in severity over a long period of time.

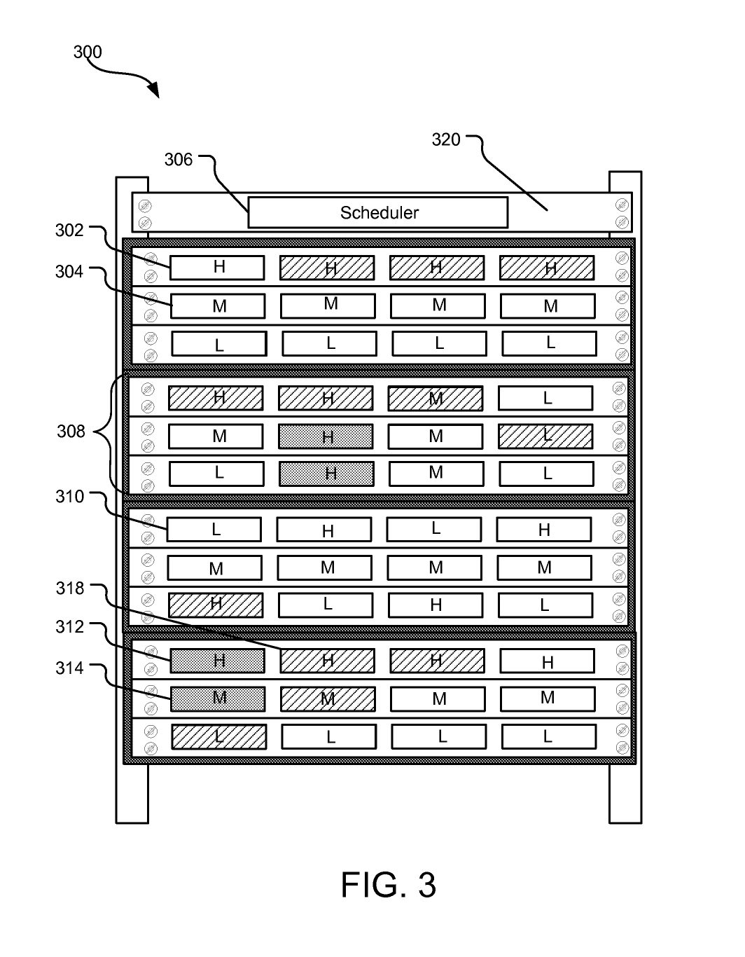

The following discussion of FIGS. 3-5 is intended to exemplify one series of actions that the distributed workload scheduler 206 might take to diagnose specific vibrational problems in one implementation. However, the specific troubleshooting methodology and adaptive distributions of the distributed workload scheduler 206 are not limited to the specific implementations discussed with respect to these figures.

FIG. 3 illustrates a second distribution of subtasks assigned to a plurality of storage nodes (e.g., storage nodes 302, 304) in a distributed computing system 300 by an example distributed workload scheduler 306. This second subtask distribution is made in response to data collected during a first distribution that is the same or similar to that described with respect to FIG. 2, above. The distributed workload scheduler 306 has performed the second distribution of subtasks based on knowledge of the physical location of each of the system storage nodes as well as the observation of unexpectedly long computing times (due to high I/O degradation) in certain storage nodes during the first distribution.

In one implementation, the distributed workload scheduler performs the second distribution 300 of the subtasks based on measurements reported from vibration sensors in the storage nodes instead of or in addition to the observation of unexpectedly long computing times in a prior distribution.

After execution of the subtasks in the second distribution 300, fewer storage nodes report disc I/O degradation and the subtasks generally run faster than during the first distribution. The distributed workload scheduler 306 analyzes the data from the first and second distributions concurrently and makes certain inferences regarding the performance requirements associated with certain workloads and/or the vibrational susceptibility of certain storage nodes in the distributed computing system 300.

In the illustrated implementation, the distributed workload scheduler 306 detects that when two or more subtasks from the workload H are scheduled on vertically adjacent storage nodes (e.g., the storage nodes 312 and 314), more severe performance degradation is seen. Additionally, the distributed workload scheduler 306 observes that when workload H is scheduled to a storage node that is horizontally adjacent to storage nodes performing other workload H subtasks (e.g., the storage nodes 312 and 318) some performance degradation is also seen. Accordingly, the distributed workload scheduler 306 creates or identifies a rule against scheduling workload H subtasks either horizontally or vertically adjacent to other workload H subtasks when possible. Using this rule, distributed workload scheduler 306 attempts a third distribution.

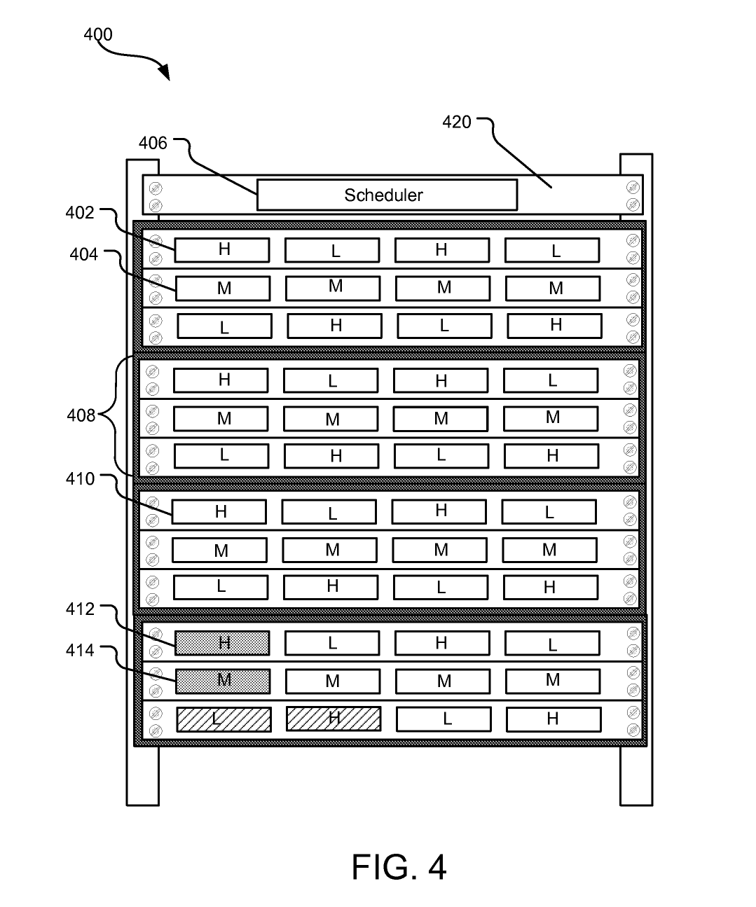

FIG. 4 illustrates a third distribution of subtasks assigned to a plurality of storage nodes (e.g., storage node 402, 404) in a distributed computing system 400 by an example distributed workload scheduler 406. This third distribution 400 is made in response to data collected during one or more earlier distributions, which may be the same or similar to the distributions described above with respect to FIGS. 2-3.

After receiving feedback from the storage nodes (e.g., storage nodes 402, 404) relating to the third distribution 400, the distributed workload scheduler 406 analyzes feedback data from the storage nodes and makes one or more inferences regarding the performance requirements associated with certain workloads and/or the vibrational susceptibility of certain storage nodes in the distributed computing system 400.

In the implementation of FIG. 4, the distributed workload scheduler 406 observes that the rule it implemented (i.e., prohibiting H subtasks on vertically or horizontally adjacent storage nodes) has been successful at resolving most of the vibrational-related performance degradation in the distributed computing system 400. However, the distributed workload scheduler 406 observes that performance problems still persist in the lower left corner of the bottom chassis, a region which as been statistically more problematic than others in all observations so far.

In different implementations, the distributed workload scheduler 406 may next take any of a number of actions to troubleshoot the performance problems in the lower-left corner of the bottom chassis. In one implementation, the distributed workload scheduler 406 attempts to identify low-workload subtasks (e.g., by identifying subtasks performed without associated performance problems in prior data sets) and schedules a series of the low-workload subtasks in the problem region to determine if the vibration-related performance problems are a result of high vibrational susceptibility of one or more HDAs in the region. In another implementation, the distributed workload scheduler 406 tracks the vibrational susceptibility of a given region over time to determine if there is a component in the region that is gradually degrading.

In yet another implementation, the distributed workload scheduler 406 attempts to determine if a persistently high temperature in the storage node is making one or more HDAs in the problem region more susceptible to performance degradation. For example, the distributed workload scheduler may analyze temperature readings in the one or more problem storage nodes (e.g., storage nodes 412 and 414) and decide high temperatures in the region are likely the source of increased vibrational susceptibility. To remedy this problem, the distributed workload scheduler may determine that a fan in the vicinity of the problem storage nodes (e.g., the storage nodes 412 and 414) needs to be run more often or at a higher speed. In another implementation, the distributed workload scheduler 406 alters the speed of the fan.

Alternatively, the distributed workload scheduler 406 may attempt to learn whether a cooling fan physically coincident with the lower-left corner of the bottom chassis region is itself causing additional vibrations. To make this assessment, the distributed workload scheduler 406 may change the rotational speed of the fan and observe whether system performance improves in a subsequent distribution of tasks.

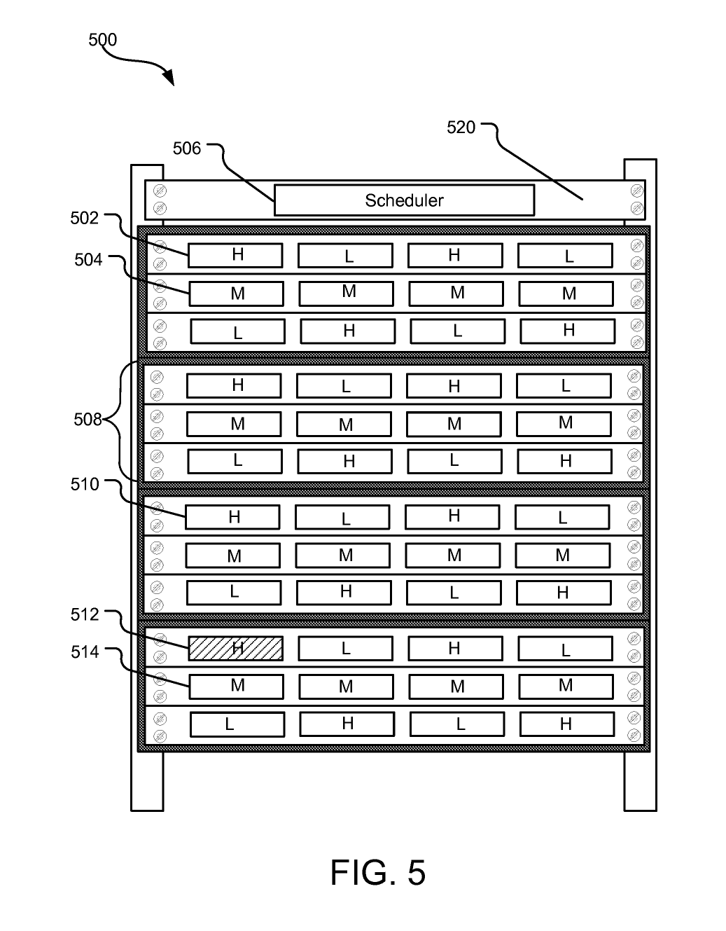

FIG. 5 illustrates a fourth distribution of subtasks assigned to a plurality of storage nodes in a distributed computing system 500 by an example distributed workload scheduler 506. This fourth distribution 500 is made in response to data collected during one or more prior distributions, which may be the same or similar to the distributions described above with respect to FIGS. 2-4. Prior to making this fourth workload subtask distribution, the distributed workload scheduler 506 has altered the speed of a fan in the lower-left corner of the bottom chassis, a region that reported experiencing high levels of vibration. Here, the distributed workload scheduler 506 observes that changing the rotational speed of the fan significantly improved the performance of the lower-left problem region; however, the problem in the lower-left region has not been completely resolved. To further troubleshoot, the distributed workload scheduler 506 may, in one implementation, continue to find other fan speeds that tend to improve region performance.

In one implementation, the distributed workload scheduler 506 suspects that observed vibration-related performance problems are due to a system component-related issue, but is unable to resolve the issue by altering system behavior. Here, the distributed workload scheduler 506 reports the suspected problem component to the system administrator for service. Specifically, the distributed workload scheduler 506 notifies a system administrator that the fan in the above example needs to be replaced at the next service interval.

In the simplified example described with respect to FIGS. 2-5, the workload H both created the vibration-related performance problems and experienced the vibration-related performance problems. However, it may be appreciated that a given workload may have a tendency to create vibration-related performance problems for other workloads while not necessarily being susceptible to such problems. Likewise, a workload may be susceptible to vibration-related performance degradation but not itself create such problems in the distributed computing system 500. For example, a workload writing operation requiring only coarse tracking may be likely to create vibration-related performance problems in an adjacent drive that is performing a reading operation that requires precise tracking Therefore, the distributed workload scheduler 506 may treat the tendency to create vibration and the tendency to be susceptible to vibration-related performance problems as two separate variables for analysis in subsequent distributions.

In addition to the examples provided above, discussed with respect to FIGS. 2-5, the distributed workload scheduler 506 gathers and/or infer information regarding the performance requirements of each workload and/or the vibrational susceptibility of each individual storage node based on storage node feedback data for each workload.

In one implementation, the distributed workload scheduler 506 creates a rule that limits or completely prohibits subtask distribution to certain system storage nodes. For example, if a particular system region exhibits extreme vibration-related performance problems with many or all assigned workloads, the scheduler may decide that the most optimal scheduling policy is to not schedule any subtasks in the problem area when other subtasks are scheduled nearby. Alternatively, the distributed computing system 500 may inform the distributed workload scheduler 506 when background activities (e.g., activities that a storage node may initiate on its own that are not related to any particular workload) are being performed, and the scheduler 506 may decide to limit when the storage nodes can perform the background activities.

In another implementation, system users creating workloads may specify a workload's approximate disc I/O performance sensitivities and the distributed workload scheduler 506 uses that information in addition to, or in place of, observed runtime behavior (e.g., workload completion times) to improve the speed at which the distributed computing system 500 adapts to mitigate system vibrations. For example, a user may specify that a particular workload is likely to make a storage node particularly sensitive to performance degradation. In response, the distributed workload scheduler 506 may decide not to assign subtasks of the vibration-sensitive workload to any storage nodes known to have persistently high vibrational susceptibility or to storage nodes that are adjacent to storage nodes concurrently performing aggressor tasks.

In another implementation, the distributed workload scheduler 506 utilizes storage node feedback data to map the vibrational susceptibility of various storage nodes across the distributed computing system 500. For example, the scheduler 506 may create a map of storage node degradation and/or storage node vibrational susceptibility attributable to system conditions such as chassis design, drive positioning within the chassis, heat, humidity, etc. Because vibrational susceptibility may change over time, the distributed workload scheduler 506 also may periodically or continuously re-map vibrational susceptibility across the storage nodes in the distributed computing system 500. Alternatively, the distributed workload scheduler 506 may utilize storage node feedback data and/or other user input to map workload-related vibrational influences in a given distribution, such as vibrational influences of aggressor workload subtasks. Thus, the distributed workload scheduler 506 may adaptively mitigate system vibration by utilizing this vibrational sources map alone or in combination with the above-described vibrational susceptibility map to distribute a workload.

In one implementation, the distributed workload scheduler 506 intelligently determines where to store redundant data in a system that creates multiple copies of certain data sets. Multiple copies may be made, for example, to provide for redundancy and subtask scheduling flexibility. In such a system, the distributed workload scheduler 506 may utilize information about the vibrational susceptibility of various storage nodes and/or the performance requirements for a given subtask to determine which physical storage nodes the additional data copies should be located on. For example, if a given data set is frequently used with disc I/O bound tasks, the distributed workload scheduler 506 may decide to place copies of that data set on storage nodes that are not known to have vibrational sensitivities. Similarly, if it is known that two datasets are frequently executed on by two sets of subtasks that frequently aggravate each other from a vibrational perspective, the distributed workload scheduler 506 may decide to place copies of the data on storage nodes sufficiently separated from one another so that the storage nodes performing the subtasks are less likely to interact with one another.

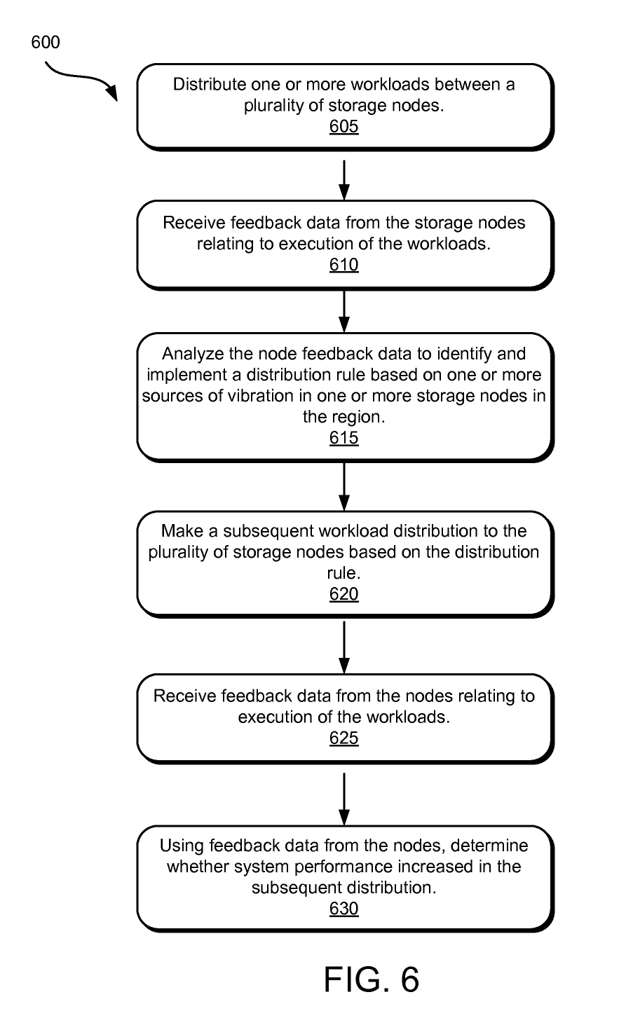

FIG. 6 illustrates example operations of adaptive rotational vibration mitigation according to one implementation. A distribution operation 605 distributes one or more workloads between a plurality of storage nodes in a distributed computing system. A receiving operation 610 receives storage node feedback data from the storage nodes relating to the execution of the one or more workloads and a distribution rule selection operation 615 analyzes storage node feedback data to identify and implement a distribution rule based on one or more known or suspected sources of vibration impacting the system.

For example, the receiving operation 610 may receive execution times for a number of subtasks assigned to different storage nodes, all relating to workload ‘A’. The distribution rule selection operation 615 may analyze the subtask execution times at each storage node and observe that the workload ‘A’ subtasks assigned to vertically adjacent storage nodes took an unusually long time to execute. From this observation, the distribution rule selection operation 615 may identify and implement a distribution rule under which subtasks from workload ‘A’ may not be assigned to vertically adjacent storage nodes in subsequent distributions.

In another implementation, the distribution rule selection operation 615 identifies a problematic region in the system that persistently experiences higher than average I/O degradation due to system vibrations, and the distribution rule selection operation 615 selects and implements a distribution rule limiting the types of subtasks that can be assigned to the problematic region.

In the same or an alternate implementation, the distribution rule selection operation 615 identifies and implements more than one relevant distribution rule based on vibration-related observations of the system. For instance, the distribution rule selection operation 615 might identify and implement both of the following rules simultaneously: (1) workload ‘A’ subtasks may not be assigned to vertically adjacent storage nodes and (2) workload ‘A’ subtasks may not ever be assigned to certain identified storage nodes that are either persistently problematic or problematic when utilized to execute workload ‘A’ subtasks.

A distribution operation 620 makes a subsequent workload distribution among the plurality of storage nodes according to the distribution rule created and another receiving operation 625 receives feedback from the storage nodes relating to the execution of the workload subtasks performed at each of the storage nodes.

A determining operation 630 determines whether system performance has increased in the subsequent distribution as compared to the prior distribution. If system performance has increased, then the distribution rule implemented may be saved and applied to future workload distributions. Additional distribution rules that further optimize system performance may also be created and applied to future workload distributions. If the determining operation 630 determines that system performance has not increased, then the rule implemented may be discarded and a different rule may be created by the rule creation operation 615. Thereafter, operations 615-630 may be repeated to assess whether the different rule created in fact had a positive impact on the performance of the system.

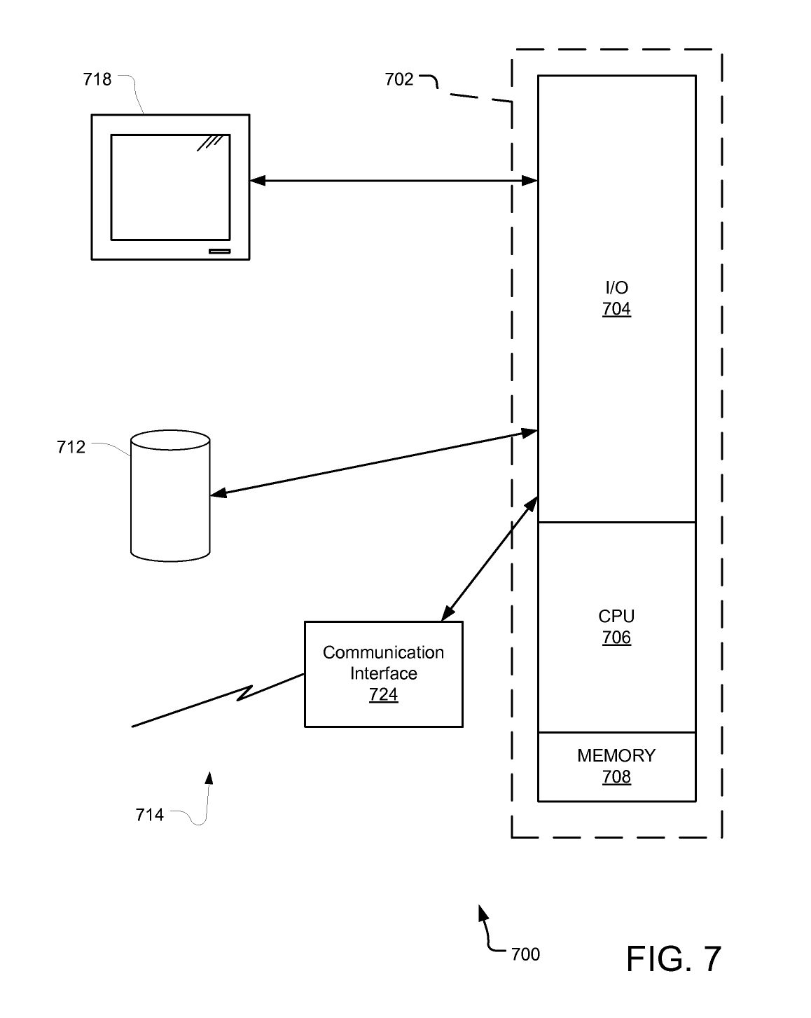

FIG. 7 discloses a block diagram of a computer system 700 suitable for implementing one or more aspects of an adaptive vibration mitigation system. In one implementation, the computer system 700 is used to implement a host server having a processor 702 that is communicatively coupled to a plurality of storage nodes (not shown) and/or one or more chassis level controllers (not shown).

The computer system 700 is capable of executing a computer program product embodied in a tangible computer-readable storage medium to execute a computer process. Data and program files may be input to the computer system 700, which reads the files and executes the programs therein using one or more processors. Some of the elements of a computer system 700 are shown in FIG. 7 wherein a processor 702 is shown having an input/output (I/O) section 704, a Central Processing Unit (CPU) 706, and a memory section 708. There may be one or more processors 702, such that the processor 702 of the computing system 700 comprises a single central-processing unit 706, or a plurality of processing units. The processors may be single core or multi-core processors. The computing system 700 may be a conventional computer, a distributed computer, or any other type of computer. The described technology is optionally implemented in software loaded in memory 708, a disc storage unit 712, and/or communicated via a wired or wireless network link 714 on a carrier signal (e.g., Ethernet, 3G wireless, 4G wireless, LTE (Long Term Evolution)) thereby transforming the computing system 700 in FIG. 7 to a special purpose machine for implementing the described operations.

The I/O section 704 may be connected to one or more user-interface devices (e.g., a keyboard, a touch-screen display unit 718, etc.) or a disc storage unit 712. Computer program products containing mechanisms to effectuate the systems and methods in accordance with the described technology may reside in the memory section 704 or on the storage unit 712 of such a system 700.

A communication interface 724 is capable of connecting the computer system 700 to a network via the network link 714, through which the computer system can receive instructions and data embodied in a carrier wave. When used in a local area networking (LAN) environment, the computing system 700 is connected (by wired connection or wirelessly) to a local network through the communication interface 724, which is one type of communications device. When used in a wide-area-networking (WAN) environment, the computing system 700 typically includes a modem, a network adapter, or any other type of communications device for establishing communications over the wide area network. In a networked environment, program modules depicted relative to the computing system 700 or portions thereof, may be stored in a remote memory storage device. It is appreciated that the network connections shown are examples of communications devices for and other means of establishing a communications link between the computers may be used.

In an example implementation, the distributed workload scheduler may be embodied by instructions stored in memory 708 and/or the storage unit 712 and executed by the processor 702. Further, local computing systems, remote data sources and/or services, and other associated logic represent firmware, hardware, and/or software, which may be configured to adaptively distribute workload tasks to improve system performance. The distributed workload scheduler may be implemented using a general purpose computer and specialized software (such as a server executing service software), a special purpose computing system and specialized software (such as a mobile device or network appliance executing service software), or other computing configurations. In addition, program data, such as task distribution information, storage node degradation information, and other data may be stored in the memory 708 and/or the storage unit 712 and executed by the processor 702.

The implementations described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the implementations of the invention described herein are referred to variously as operations, steps, objects, or modules. Furthermore, it should be understood that logical operations may be performed in any order, adding and omitting as desired, unless explicitly claimed otherwise or a specific order is inherently necessitated by the claim language.

The above specification, examples, and data provide a complete description of the structure and use of exemplary implementations of the invention. Since many implementations of the invention can be made without departing from the spirit and scope of the invention, the invention resides in the claims hereinafter appended.

What is claimed is:

1. A method comprising:
allocating a workload among a plurality of storage nodes based on a vibrational susceptibility determined for at least one of the plurality of storage nodes.

2. The method of claim 1, wherein allocating the workload among the plurality of storage nodes is based on a relativity of vibrational susceptibilities of at least two of the plurality of storage nodes.

3. The method of claim 1, wherein allocating the individual workload further comprises:
detecting a first performance degradation experienced at a first storage node performing a workload task;
detecting a second performance degradation experienced at a second storage node performing the workload task;
allocating a subsequent instance of the workload task to a third storage node based on the performance degradation detected at the first and second storage nodes.

4. The method of claim 1, wherein the vibrational susceptibility is determined based on an identification of at least one physically degraded component.

5. The method of claim 1, wherein the vibrational susceptibility is determined based on a type of subtask being performed on one or more adjacent storage nodes.

6. The method of claim 1, wherein the vibrational susceptibility is determined based on a performance requirement of a subtask allocated to the at least one of the plurality of storage nodes.

7. The method of claim 1, further comprising:
affecting a power state of a system component in order to reduce vibrational susceptibility of at least one of the plurality of storage nodes.

8. The method of claim 1, further comprising:
notifying a system administrator of a persistent problem in one of the storage nodes.

9. The method of claim 1, further comprising:
limiting when background activities may be performed on other storage nodes in the system based on the vibrational susceptibility determined for the at least one of the plurality of storage nodes.

10. The method of claim 1, wherein the vibrational susceptibility determined for the at least one of the plurality of storage nodes varies with time.

11. The method of claim 1, wherein allocating the workload among the plurality of storage nodes further comprises:
allocating the workload among the plurality of storage nodes based on a vibrational susceptibility determined for the at least one of the plurality of storage nodes at two or more different times.

12. The method of claim 1, wherein the vibrational susceptibility is determined based on a temperature communicated to the workload scheduler.

13. A system comprising:
a plurality of storage nodes;
a workload scheduler communicatively coupled to the plurality of storage nodes and configured to allocate workloads among the plurality of storage nodes based on a vibrational susceptibility determined for at least one of the plurality of storage nodes.

14. The system of claim 13, wherein the workload scheduler is configured to allocate workloads among the plurality of storage nodes based on a relativity of vibrational susceptibilities of at least two of the plurality of storage nodes.

15. The system of claim 13, wherein the vibrational susceptibility is determined based on a relative location of the at least two of the plurality of storage nodes within the system.

16. The system of claim 13, wherein the vibrational susceptibility is determined based on a type of subtask being performed on one or more adjacent storage nodes.

17. The system of claim 13, wherein the vibrational susceptibility is determined based on a performance requirement of a subtask allocated to the at least one of the plurality of storage nodes.

18. The system of claim 13, wherein the vibrational susceptibility is determined based on a temperature communicated to the workload scheduler.

19. The system of claim 13, wherein the vibrational susceptibility is determined based on an identification of at least one physically degraded system component.

20. The system of claim 13, wherein the workload scheduler is further configured to limit when background activities are performed based on the vibrational susceptibility determined for the at least one of the plurality of storage nodes.

21. The system of claim 13, wherein the workload scheduler is configured to allocate the workload among the plurality of storage nodes based on a vibrational susceptibility determined for the at least one of the plurality of storage nodes at two or more different times.

22. One or more computer-readable storage media encoding computer-executable instructions for executing on a computer system a computer process, the computer process comprising:
allocating a workload among a plurality of storage nodes based on a vibrational susceptibility determined for at least one of the plurality of storage nodes.

23. The one or more computer-readable storage media of claim 22, wherein allocating the workload among the plurality of storage nodes is based on a relativity of vibrational susceptibilities of at least two of the plurality of storage nodes.

24. The one or more computer-readable storage medium of claim 23, wherein the vibrational susceptibility is determined based on a relative location of the at least two of the plurality of storage nodes within the system.

25. The one or more computer-readable storage media of claim 22, wherein allocating the individual workload further comprises:
detecting a first performance degradation experienced at a first storage node performing a workload task;
detecting a second performance degradation experienced at a second storage node performing the workload task;
allocating a subsequent instance of the workload task to a third storage node based on the performance degradation detected at the first and second storage nodes.

26. The one or more computer-readable storage medium of claim 22, wherein the vibrational susceptibility is determined based on an identification of at least one physically degraded component.

27. The one or more computer-readable storage medium of claim 22, wherein the vibrational susceptibility is determined based on a type of subtask being performed on one or more adjacent storage nodes.

28. The one or more computer-readable storage medium of claim 22, wherein the vibrational susceptibility is determined based on a performance requirement of a subtask allocated to the at least one of the plurality of storage nodes.

29. The one or more computer-readable storage medium of claim 22, wherein the computer-readable storage medium is configured to limit when background activities are performed on storage nodes in the system based on the vibrational susceptibility determined for the at least one of the plurality of storage nodes.

30. The one or more computer-readable storage medium of claim 22, wherein allocating the workload among the plurality of storage nodes further comprises:
allocating the workload among the plurality of storage nodes based on a vibrational susceptibility determined for the at least one of the plurality of storage nodes at two or more different times.
